(19) United States
(12) Patent Application Publication
(10) Pub. No.: US 2013/0122975 A1
(43) Pub. Date: May 16, 2013

(54) RADIATION PROTECTOR FOR MOBILE DEVICES

(71) Applicant: Duong Huy Ha, Santa Monica, CA (US)

(72) Inventor: Duong Huy Ha, Santa Monica, CA (US)

(21) Appl. No.: 13/672,695

(22) Filed: Nov. 8, 2012

Related U.S. Application Data
(63) Continuation-in-part of application No. 13/668,284, filed on Nov. 4, 2012.
(60) Provisional application No. 61/585,600, filed on Jan. 11, 2012.
(60) Provisional application No. 61/560,490, filed on Nov. 16, 2011.

(51) Int. Cl. H04B 1/38; G21F 3/02; G21F 3/00

(52) U.S. Cl. CPC H04B 1/3838; G21F 3/00; G21F 3/02
USPC 455/575.5; 250/519.1; 250/516.1

(57) ABSTRACT

A radiation protector is disclosed for protecting against radiation having a wavelength. The radiation protector comprises a carbon layer comprising a carbon weave in the form of a veil or mesh, and having an outer edge. A metal layer comprises a metal fabric weave, and has an outer edge. The outer edge of the metal layer is recessed from the outer edge of the metal layer by a width w, wherein w is a fraction of the wavelength of the radiation.

### RELATED APPLICATION INFORMATION

This application is a continuation-in-part of U.S. application Ser. No. 13/668,284 entitled “Radiation Protector For Mobile Devices”, filed Nov. 4, 2012, which is a non-provisional of Provisional Application Ser. No. 61/585,600, entitled “Hood and Garment That Protects Against Cellular Phone and Microwave Energy”, filed Jan. 11, 2012, and is a non-provisional of Provisional Application Ser. No. 61/560,490, entitled “Fabric That Protects Against Cellular Phone Energy”, filed Nov. 16, 2011, and claims priority from those applications and incorporates them by reference.

### FIELD OF THE INVENTION

The present invention generally relates to a radiation protector for mobile devices and the like. More specifically, the invention relates to a radiation protector that may be customized to the wavelength of an electronic device emitting potentially harmful radiation to provide maximum protection.

### BACKGROUND OF THE INVENTION

Cell phones and other mobile devices are extremely prevalent nowadays, being used not only for communications but also for entertainment purposes. However, the effect of mobile phone radiation on human health is the subject of recent interest and study, as a result of the enormous increase in mobile phone usage throughout the world (as of November 2011, there were more than 5.981 billion subscriptions worldwide). Mobile phones use electromagnetic radiation in the microwave range. Other digital wireless systems, such as data communication networks, produce similar radiation.

The World Health Organization (WHO) has classified mobile phone radiation on the International Agency for Cancer Research (IARC) scale into Group 2B—possibly carcinogenic. That means that there could be some risk of carcinogenicity, so additional research into the long-term, heavy use of mobile phones needs to be conducted. Some national radiation advisory authorities have recommended measures to minimize exposure to their citizens as a precautionary approach.

In February 2009, the telecom company Bouygues Telecom was ordered to take down a mobile phone mast due to uncertainty about its effect on health. Residents in the commune Charbonniéres in the Rhône department had sued the company claiming adverse health effects from the radiation emitted by the 19 meter tall antenna. The milestone ruling by the Versailles Court of Appeal reversed the burden of proof which is usual in such cases by emphasizing the extreme divergence between different countries in assessing safe limits for such radiation. The court stated, considering that, while the reality of the risk remains hypothetical, it becomes clear from reading the contributions and scientific publications produced in debate and the divergent legislative positions taken in various countries, that uncertainty over the harmlessness of exposure to the waves emitted by relay antennas persists and can be considered serious and reasonable.

In October 2012 Italian high court (Corte suprema di cassazione) granted an Italian businessman, Innocente Marcoloni a pension for occupational disease, as they found a causal link with his benign brain tumor to mobile phones and cordless phones, that the businessman had used for six hours a day during twelve years. As it takes time to develop cancer, the court disregarded short-term studies. The Court also disregarded studies that were even partially funded by the mobile phone industry such as the INTERPHONE.

To counter the effects of this harmful radiation, metallic shields have been developed. Unfortunately, these metallic shields alone are insufficient to absorb the harmful radiation emitted by these electronic devices to the point where it would not harm the body. Therefore, there is still a need for a shield that can absorb the harmful radiation emitted by these mobile devices to allow users to use these devices without harm.

### SUMMARY OF THE INVENTION

According to a preferred embodiment, a radiation protector, said radiation having a wavelength, comprises a carbon layer comprising a carbon weave in the form of a mesh or veil, and having an outer edge; and a metal layer comprising a metal fabric weave, and having an outer edge; wherein the outer edge of the metal layer is recessed from the outer edge of the metal layer by a width w, wherein w is a fraction of a the wavelength of the radiation.

According to another preferred embodiment, a garment for radiation protection comprises an inner layer of garment fabric; and a carbon fabric layer in the form of a mesh or veil; a metal fabric layer; an electro-magnetic absorbent layer; and an outer layer of garment fabric.

According to another preferred embodiment, a radiation protector, said radiation having a wavelength, comprises a carbon layer comprising a carbon weaving mesh or veil, and having an outer edge, or border, and a metal layer comprising a metal fabric weave; wherein the metal layer is recessed from the carbon layer by a width w, where w is a fraction, for example, ½ to ⅛, of the wavelength of the radiation.

### BRIEF DESCRIPTION OF THE DRAWINGS

FIG. 1 is a diagrammatic view of a fabric that protects against cellular phone energy according to one embodiment;

FIG. 2 is diagrammatic front elevational view of an exemplary mobile phone holder that can utilize the fabric of FIG. 1 to protect a user according to one embodiment;

FIG. 3 is diagrammatic back elevational view of the mobile phone holder of FIG. 2;

FIG. 4 is diagrammatic side elevational view of the mobile phone holder of FIG. 2;

FIG. 5 is a diagrammatic front elevational view of the unfolded assembly of the mobile phone holder of FIG. 2;

FIG. 6 is a diagrammatic back elevational view of the unfolded assembly of the mobile phone holder of FIG. 2;

FIG. 7 is a diagrammatic side perspective view of the hood garment that may use the fabric of FIG. 1;

FIG. 8 is an exploded diagrammatic side view of the hood garment of FIG. 7;

FIG. 9 is a front elevational view of the exemplary mobile phone holder of FIG. 2 with a mobile phone shown inserted;

FIG. 10 is diagrammatic side elevational view of the mobile phone holder with the mobile phone inserted according the embodiment of FIG. 9; and

FIG. 11 is a diagrammatic rear elevational view of the mobile phone holder with the mobile phone inserted according to the embodiment of FIG. 9.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

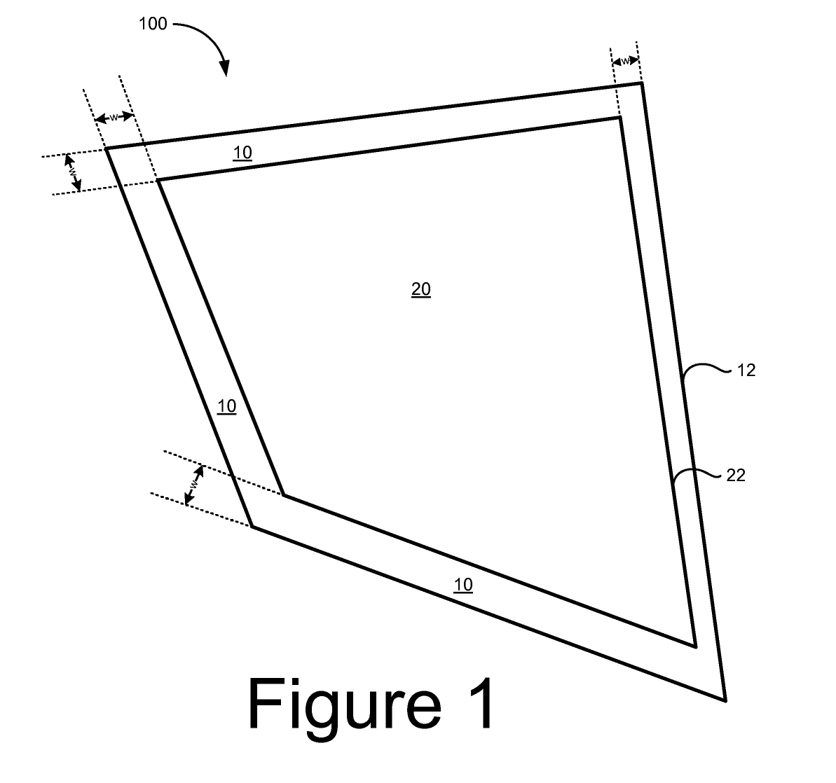

Broadly, embodiments of the present invention generally provide a radiation protector for mobile devices and the like. With reference to FIG. 1, a diagrammatic view of a fabric that protects against cellular phone energy according to one embodiment is shown. The fabric 100 may be used to shield microwave energy transmitted to and from a portable electronic device such as a cell phone, other sources of radiation (e.g. sunlight, microwave ovens, etc.), or the like. The fabric 100 may be attached to a pocket of a garment such as a pair of pants, or some location where a user wears the electronic device such as a purse lining, or also in an airplane shade, or the like. The fabric 100 may also be integrated into a hat at a location that will protect a user's ear, such as a blue tooth cover, or the like, so the user may make calls hands free while driving without having to worry about radiation exposure to the body, eyes, or brain.

The fabric 100 may comprise a carbon layer or weave 10 and a metal layer 20. In one embodiment, by way of example and not by way of limitation, the metal layer 20 may comprise an aluminum weave.

The carbon layer 10 may absorb the microwave energy and convert the energy into heat. The metal layer 20 may reflect the radiation from the radiation source away from the user and whatever remaining radiation is dissipated by the carbon layer 10 and the carbon layer converts it to low heat. The metal layer 20 may preferably be located on the outside surface of the carbon layer 10 so that the carbon layer can absorb any remaining radiation and transform the radiation into low heat and the heat will dissipate through convection.

In one embodiment, the metal layer 20 may comprise a weave of a metal material, such as aluminum or copper, and a garment material such as cotton. In one embodiment, by way of example and not by way of limitation, the metal layer 20 may comprise 90% cotton and a 10% metal weave.

The actual thickness measurements and densities of the layers need not be fixed and may comprise different measurements and densities according to applications in different embodiments. However, by way of example and not by limitation, in one embodiment, the metal layer 20 may comprise a metal fabric weave may be 0.445 mm thick and have a density of metal of 0.115 gm/m².

By way of example and not by way of limitation, according to one embodiment, the carbon layer 10 may comprise a weave of a carbon fiber and garment material. By way of example, and not by way of limitation, the carbon layer may be 0.66 mm thick and have a carbon density of 0.349 gm/m².

In one embodiment, for maximum effectiveness in radiation protection, the outer edge 22 of the metal layer 20 may be recessed from the outer edge 12 of the carbon layer 10. In FIG. 1, the distance between the outer edge 12 and the outer edge 22 is shown as width w. In one embodiment, width w may relate to the wavelength of signals of the mobile device being used. For example, mobile phones make use of various bands of radio frequencies to communicate between the mobile phone to a base station for a cell and the base station to mobile phone. In Europe, for example, these frequencies include 900 and 1800 MHz. In the United States and Canada, these frequencies include 850 and 1900 MHz.

The relationship between the wavelength, the speed of light and the frequency follows the well-known formula:

Wavelength λ (m)=speed of light/frequency=c (ms⁻¹)/v (Hz)

λ (m)=300,000,000/v (Hz) or approximately:

λ (m)=300/v (MHz)

So for a mid-range of about 1000 MHz (1 GHz) a typical mobile phone wavelength is about:

λ=300/1000=0.3 m=30 cm.

In one embodiment, width w may be configured to be one eighth (⅛) the wavelength of the particular mobile device, or by way of example and not by way of limitation, 3.75 cm for a mobile phone using a 30 cm signal wavelength.

In another embodiment w may be configured to be one fourth (¼) the wavelength of the particular mobile device, or by way of example and not by way of limitation, 7.5 cm for a mobile phone using a 30 cm signal wavelength.

In other embodiments, there may be other effective fractions of the mobile device's wavelength by which w may be configured for maximum radiation protection. In other words:

w=λ/x

where x represents a selected denominator of a fraction of the wavelength to determine width w.

In one embodiment, the carbon layer 10 may be in the form of a mesh or veil to increase the cavity volume, and therefore decrease the photon energy density from the electronic device being absorbed by the body based on the following equation:

Number of modes per unit wavelength/cavity volume=(−1/L³)(dN/dA)=8π/λ⁴

Where L is the diameter of the cavity, d is the differential of the wavelength. In one embodiment, the mesh is woven in different coordinate-systems to increase effectiveness in blocking the radiation from all directions. This may also aid in transparency for the user to view and use phone operations within the protective covering. For example, the absorption rate of a sponge is equal to the cavity volume of the sponge or the cavity volume of a bee hive determines the amount of honey, and radiation obeys the same principle.

The fabric 100 may be used anywhere a user desires to gain protection from radio wave radiation. By way of example, and not by way of limitation, the fabric 100 may be used to make garment pockets, cell phone holders (as described below), clothing lining (such as the hood described below), and the like. The specific examples described herein are meant to illustrate mere examples, and are not described in the limiting sense.

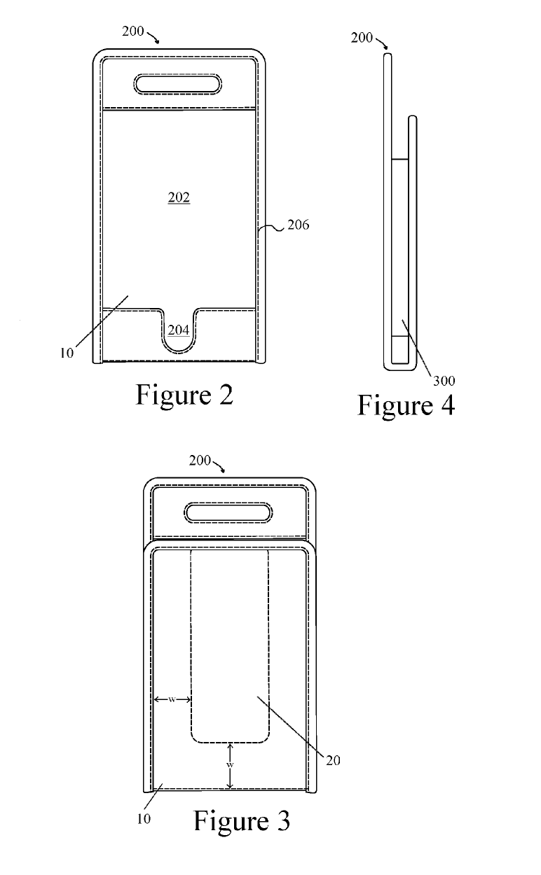

With reference to FIG. 2, a diagrammatic front elevational view of an exemplary mobile phone holder 200 that can utilize the fabric 100 of FIG. 1 to protect a user according to one embodiment is shown. In one embodiment, the carbon layer 10 may comprise a main body of the mobile phone holder, folded around the bottom, leaving a top opening in which the mobile phone may be inserted.

With reference FIG. 3, a diagrammatic back elevational view of the mobile phone holder of FIG. 2 is shown. As shown in FIG. 3, the carbon layer 10 may be folded over to form a pocket shape for the holder 200 of the mobile phone. However, sewn into the back portion of the holder 200 shown in FIG. 3 may be the metal layer 20. In one embodiment, the metal layer 10 may be sewn in between two sub layers of the carbon layer 20. Optionally, sewing may not be necessary as the metal layer 20 may be merely sandwiched within the carbon layer 10. As shown in FIG. 3, the metal layer 10 may be sized such that the width w requirements explained above are met.

With reference back to FIG. 2, in one embodiment, an optional feature includes a peelable front panel 202 that may be peeled back to expose a touch screen on a smart phone that is in use with the holder 200. Further, the front panel 202 may be of sufficiently thin carbon such that it is reasonably transparent so the user may view operations on the smart phone's face, and so the user may peel back the front panel 202 to operate the touch screen when needed. Further, a side seam 206 may be separable from the rest of the body of the holder to allow for peeling back of the front panel. Finally, a pull tab 204 provides for easy pulling of the front panel 202.

With reference to FIG. 4, a diagrammatic side elevational view of the mobile phone holder of FIG. 2 is shown. When the fabric 100 is folded over to form the holder 200, side panels 300 may be used to form the sides of the holder 200. In one embodiment, the side panels 300 may be sewn to the front and back portions of the folded fabric 100, and may be made of a suitable material, such as elastic gore, Velcro® which attaches without sewing, or the like.

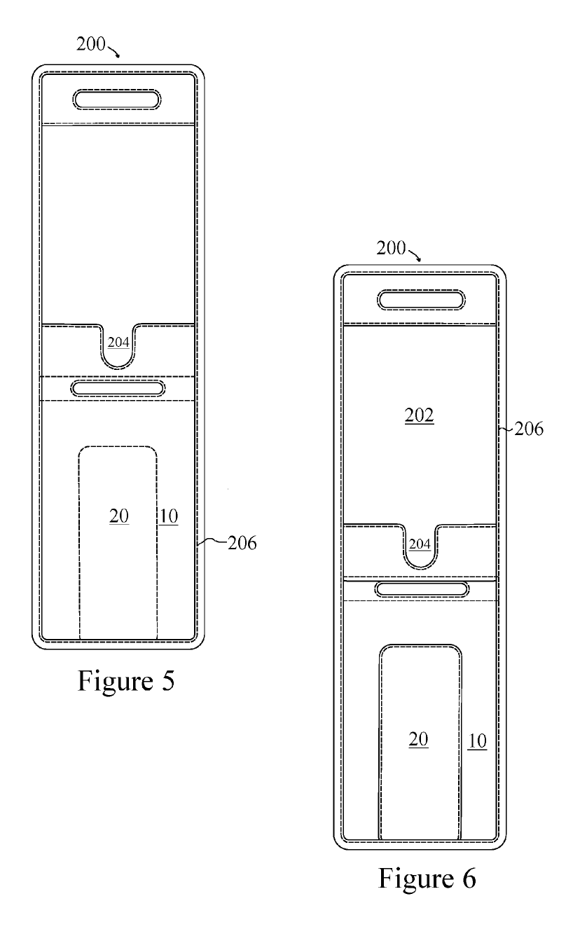

With reference to FIG. 5, a diagrammatic front elevational view of the unfolded assembly of the mobile phone holder of FIG. 2 is shown. With reference to FIG. 6, a diagrammatic back elevational view of the unfolded assembly of the mobile phone holder of FIG. 2 is shown. The unfolded assembly diagrams of FIGS. 5 and 6 illustrate the ease of manufacture of the holder 200. Once the metal layer 20 is sewn into the carbon layer 10, the manufacturer merely needs to fold over the assembly and sew in the side panels 300 to form the assembled holder 200. The configuration adds to washability.

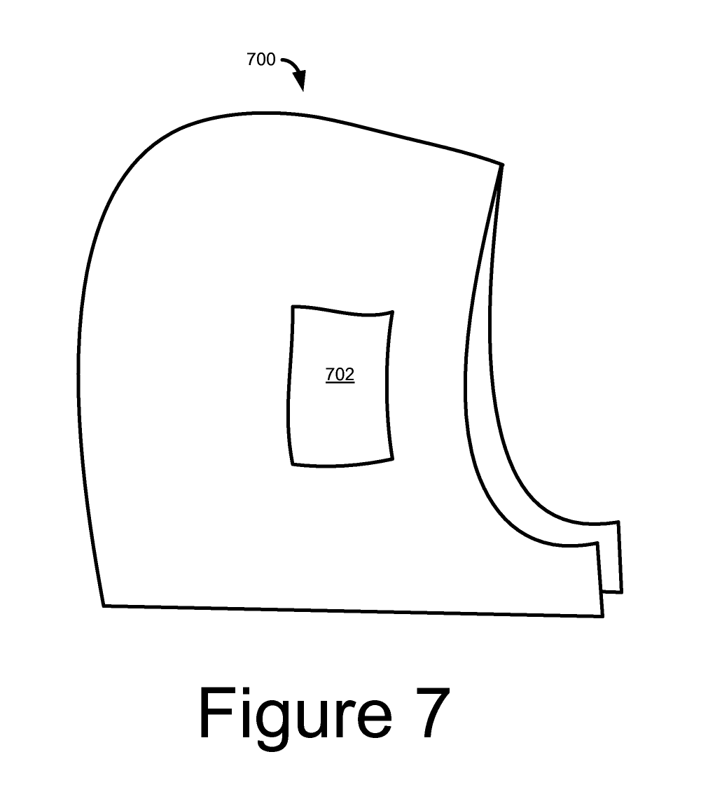

With reference to FIG. 7, a diagrammatic side perspective view of a hood garment 700 that may use the fabric 100 of FIG. 1 is shown. On the outer layer of both sides of the hood, there are one or more small pockets 702 for hands free, bluetooth, or earphone devices.

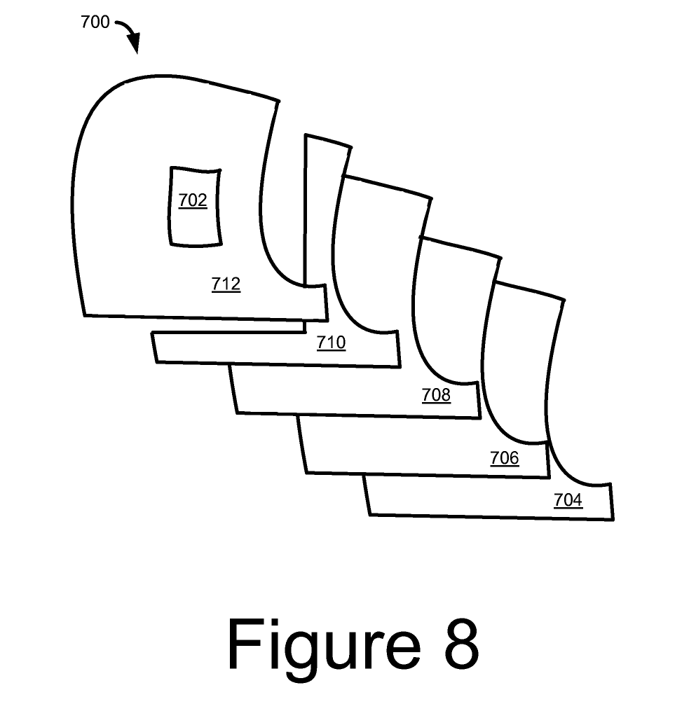

With reference to FIG. 8, an exploded diagrammatic side view of the hood garment of FIG. 7 is shown. The layers of fabric may be seamed at the edges, or additionally quilted for stability. The hood 700 may comprise five layers of fabric. The inner layer 704 may be made of conventional fabric and is selected for comfort near the skin. The next layer 706 may be made of a radiofrequency absorbing material, typically carbon fiber-based. A third metal layer 708 may comprise a metallic fiber that reflects the electro-magnetic waves. A fourth, partial layer 710, which may be, in one embodiment, approximately two inches wide at the edge of the hood, may also be made of absorbing material to attenuate any surface electro-magnetic waves which may travel to the edge of the metallic layer. A fifth and outer layer 712 may comprise a conventional fabric chosen for appearance, flexibility, and durability.

A pocket 702 of conventional fabric may be attached to the side of the hood, positioned to place the cell phone, or a hands-free device, over the ear for hands-free use. The pocket 702 may be adjustable to accommodate people of different sizes. Alternatively, multiple pockets 702 may be provided to allow the user to select which pocket to use two most closely bring the hands-free device to the user's ear.

In one embodiment, the hood garment 700 may comprise a carbon fabric layer 706 and a metal (e.g., silver, copper, or aluminum) layer 708, and a conventional fabric (such as silk) could be added to avoid allergic reactions, discomfort, and the like, if any. The carbon layer 706 may absorb the microwave energy and convert the energy into heat. The metal layer 708 may conduct and reflect the microwave radiation and heat generated by a mobile phone during the time it is on or in use. The metal layer 708 may be located on the outside surface of the conventional fabric or carbon layer so that the radiation and heat may be transferred from the fabric through convection. The hood garment 700 may include an inner and outer layer of fabric for comfort and style.

In one embodiment, the metal layer 708 may be a knitting of a metal (silver, copper, aluminum) material and garment material, such as cotton having surface resistivity of approximately 3 ohms to approximately 200 ohms. The metal layer 708 may comprise approximately 70 percent to approximately 90% garment material, such as cotton, rayon, and the like, and approximately 7% to approximately 20% of the metal. In one embodiment, it may comprise approximately 84 percent of the garment material, and approximately 16% of the metal. The metal fabric 708 may be 0.225 mm to 0.700 mm thick, and may be 0.445 mm thick and have a weight of approximately 100 gm/m² to approximately 200 gm/m². In one embodiment, the metal fabric may have a weight of approximately 134 gm/m². The yarn count of the metal fabric may be approximately 64/30 dtex to approximately 22/106 dtex with a jersey knit, or weave. In one embodiment, the metal fabric may have a yarn count of approximately 44/12 dtex.

The carbon fabric may be a weave of approximately 1×1 to approximately 4×4 twill, and preferably approximately 2×2 twill, with approximately 2000 thread to approximately 6000 thread carbon fiber and fabric material, but preferably 4000 thread. The carbon fiber fabric and garment material may be approximately 30 percent to approximately 70 percent carbon, and preferably 65 percent carbon, with approximately 1 inch to approximately 10 inches of overlap, and preferably approximately 3 inches to approximately 6 inches of overlap as shown in the figures.

The carbon layer 708 on the hood and any garment may be approximately 0.4 mm to approximately 2 mm thick. In one embodiment the carbon layer 708 is approximately 0.66 mm thick. The carbon layer 708 may have a density of approximately 100 g/m² to approximately 500 g/m². In one embodiment, the carbon layer is approximately 349 gm/m². The fabric may also be used as carrying bag linings.

In embodiments using three side pockets 702, each side of the hood may have three pockets aligned vertically. Each pocket 702 may be 1.5 inch wide and 1 inch high. The total area covered by the pockets maybe 2.5 inches wide and 5 inches high.

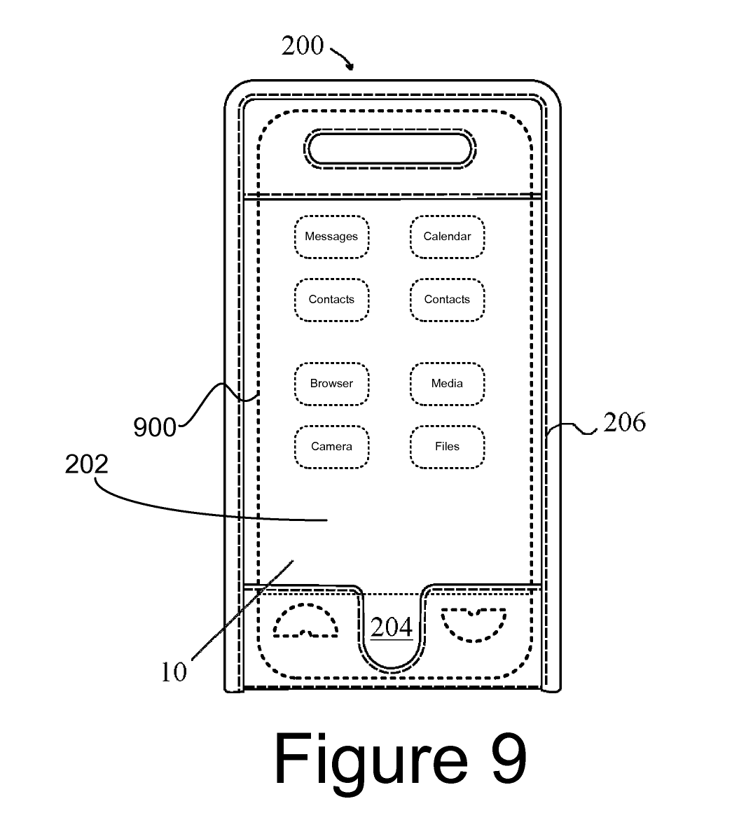

With reference to FIG. 9, a front elevational view of the exemplary mobile phone holder 200 of FIG. 2 is shown with a mobile phone 900 inserted. The portion of the phone 900 that is under the carbon mesh 10 of the peelable front panel 202 is shown in phantom. As stated above, the carbon mesh 10 may be configured such that the icons of the phone 900, and other phone controls that are under the carbon mesh 10, are visible through the carbon mesh 10, while still allowing the carbon mesh 10 to function to dissipate heat energy that is converted from the absorption of electromagnetic radiation by the holder 200. Further, when the user desires clear access to the face of the phone 200, the front panel 202 may be opened with the assistance of the pull tab 204.

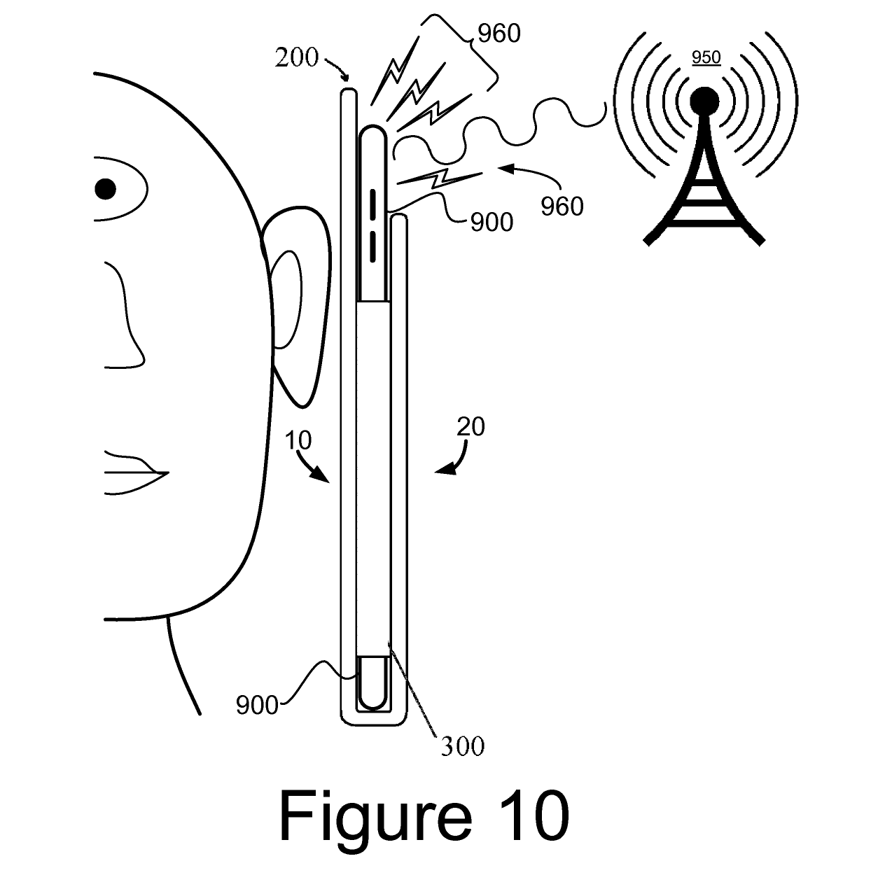

With reference to FIG. 10, a diagrammatic side elevational view of the mobile phone holder 200 with the mobile phone 900 inserted according the embodiments of FIG. 9 and FIG. 4 is shown. Also shown in FIG. 10 is an exemplary mobile tower 950 with which the mobile device 900 communicates giving off electromagnetic radiation 960.

As shown in FIG. 10, in the embodiment shown, the front side of the holder that is primarily of carbon mesh 10 is configured at a height that may be higher (or longer) than the height of the phone 900, while the back side of the holder that has a large portion or more comprised of the metallic mesh 20 may have a height that is lower or shorter than the mobile phone 900. As shown, this may allow for the signals between at least the top portion of the mobile phone 900 and the tower 950 to freely travel. An added benefit to this configuration takes advantage of the typical path of electromagnetic radiation 960 from a mobile device, which usually occurs in a perpendicular direction of the path to the user's head, while the sound waves from the phone 900 typically have a parallel course with respect to the user's head and ears. Thus, the electromagnetic radiation 960 is absorbed more effectively due to the location of the metallic mesh 20 and the width w between the outer edge 12 and the outer edge 22, with the carbon mesh 10 providing dispersion of the heat energy produced by conversion of the radiation 960.

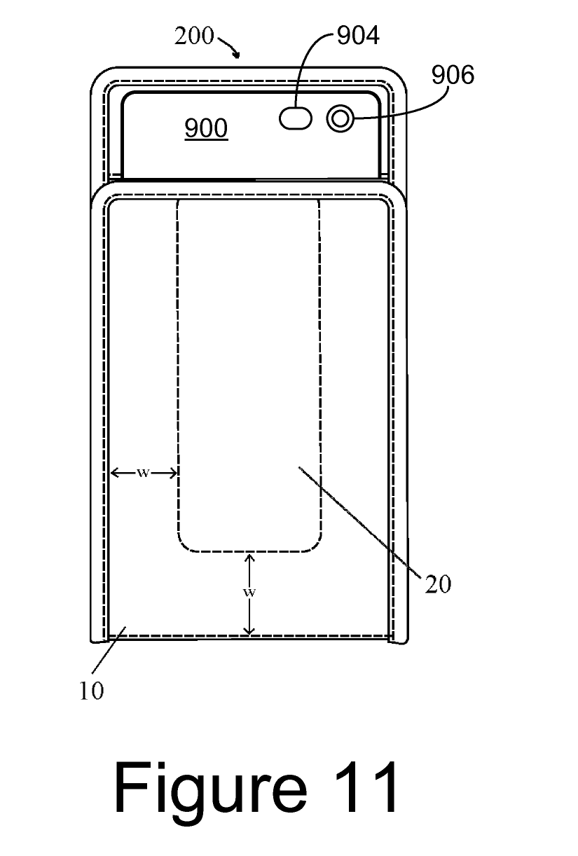

With reference to FIG. 11, a diagrammatic rear elevational view of the mobile phone holder 200 with the mobile phone 900 inserted according to the embodiments of FIG. 9 and FIG. 3 is shown. FIG. 3 illustrates yet another advantage of having the front portion of the holder 200 being taller than the back portion to expose, by way of example, a camera 906 or sonar 904 for camera focus, or the like. What is also advantages to the this configuration is the fact that many cell phones have internal antennas in the top portion of the phone 900 where the phone 900 may be exposed from the holder 200, thereby enhancing reception for the phone 900.

In some embodiments of the fabric (100 in FIG. 1) as applied to garments, including the hood 700 depicted in FIGS. 8 and 9, and/or the phone holder 200 of FIGS. 2-6 and 8-11, it should be noted that the carbon fabric 10 may be in the form of a veil, mesh or weave, which may increase the effectiveness of radiation absorption and transference to heat energy for protection of the user. As an example, such a configuration may allow a garment to have maximum effectiveness while flying in an airplane, when humans typically have a greater exposure to solar radiation than when nearer to the ground because the width w in the carbon fabric absorbs the remaining radiation from the metal layer, and thus protects the user.

It should be understood, of course, that the foregoing relates to exemplary embodiments of the invention and that modifications may be made without departing from the spirit and scope of the invention as set forth in the following claims.

1. A phone holder for radiation protection, said radiation having a wavelength, comprising:
a front portion being primarily a carbon layer comprising a carbon weave, and having an outer edge; and
a back portion having a metal layer comprising a metal fabric weave, and having an outer edge;
wherein the outer edge of the metal layer is recessed from the outer edge of the metal layer by a width w, wherein w is a fraction of a the wavelength of the radiation.

2. The phone holder of claim 1, wherein the carbon layer and the metal layer comprise a layered fabric.

3. The phone holder of claim 1, wherein the front portion exceeds the length of a phone to be inserted into the phone holder, and the front portion exceeds the length of the rear portion.

4. The phone holder of claim 3, wherein phone exceeds the length of the rear portion.

5. A radiation protector, said radiation having a wavelength, comprising:
a carbon layer comprising a carbon weave, and having an outer edge, the carbon weave further having a cavity volume sufficient for maximized absorption of radiation energy; and
a metal layer comprising a metal fabric weave capable of absorbing the radiation, and having an outer edge;
wherein the outer edge of the metal layer is recessed from the outer edge of the metal layer by a width w, wherein w is a fraction of a the wavelength of the radiation.

6. The radiation protector of claim 5, wherein the carbon layer and the metal layer comprises a layered fabric.

7. The radiation protector of claim 6, wherein the garment comprises a hood.

8. The radiation protector of claim 6, wherein the garment comprises a shirt.

9. The radiation protector of claim 6, wherein the carbon fabric comprises a veil.

10. The radiation protector of claim 6, wherein the carbon fabric comprises a mesh.
